(19) United States
(12) Patent Application Publication
(10) Pub. No.: US 2013/0111923 A1
(43) Pub. Date: May 9, 2013

(54) GAS TURBINE ENGINE COMPONENT AXIS CONFIGURATIONS

(71) Applicant: ICR Turbine Engine Corporation, Hampton, NH (US)

(72) Inventors: Frank Wegner Donnelly, North Vancouver (CA); David William Dewis, North Hampton, NH (US); John D. Watson, Evergreen, CO (US); Douglas W. Swartz, Wheat Ridge, CO (US)

(73) Assignee: ICR Turbine Engine Corporation, Hampton, NH (US)

(21) Appl. No.: 13/655,128

(22) Filed: Oct. 18, 2012

Related U.S. Application Data
(60) Provisional application No. 61/548,419, filed on Oct. 18, 2011.

(51) Int. Cl. F02C 7/143

(52) U.S. Cl. CPC F02C 7/143
USPC 60/792

(57) ABSTRACT

A method is disclosed to enable the efficient physical packaging of gas turbine engine components to optimize power density, more readily integrate with other equipment and facilitate maintenance. The method illustrates dense packaging of turbomachinery by close-coupling of components, and rotation of various engine components with respect to engines and/or other engine components, and reversal of spool shaft rotational direction to suit the application. Engines can be dense-packed because of a number of features of the basic engine including the use of compact centrifugal compressors and radial inlet turbine assemblies, the close coupling of turbomachinery, the ability to rotate key components to facilitate ducting and preferred placement of other components, the ability to control spool shaft rotational direction and full power operation at high overall pressure ratios.

### CROSS REFERENCE TO RELATED APPLICATION

The present application claims the benefits, under 35 U.S.C.§119(e), of U.S. Provisional Application Ser. No. 61/548,419 entitled “Gas Turbine Engine Component Axis Configurations” filed Oct. 18, 2011 which is incorporated herein by reference.

### FIELD

The present disclosure relates generally to gas turbine engine systems and specifically to physical packaging of gas turbine engines components to optimize power density, more readily integrate with other equipment and facilitate maintenance.

### BACKGROUND

In the search for efficient engine and fuel strategies, many different power plant and power delivery strategies have been investigated. The gas turbine or Brayton cycle power plant has demonstrated many attractive features which make it a candidate for advanced vehicular propulsion and power generation. Gas turbine engines have the advantage of being highly fuel flexible and fuel tolerant. Additionally, these engines burn fuel continuously and at a lower temperature than reciprocating engines so produce substantially less NOx per mass of fuel burned.

In vehicular applications, an engine must be fit into the vehicle's engine compartment and be mated to the vehicle's transmission system. A Class 8 vehicle will have substantially different packaging requirements than a Class 5 delivery vehicle, an SUV or a pick-up truck for example.

For power generation, packaging requirements are different from those of a vehicle and an engine must be packaged along with power electronics, often in settings that require the engine or engines to fit more efficiently in confined spaces.

In both vehicle and power generation applications, multiple engine configurations may be used. For example, two or more engines may be packaged to provide a power plant for a locomotive. Two or more smaller engines (in the range of about 200 kW to about 1,000 kW at full power) may be packaged to provide back-up power for a multi-megawatt renewable power generating facility.

There remains a need for a versatile engine design whose components can be arranged to fit the packaging requirements of various vehicles from small cars and trucks to large trucks and for various power generation applications from back-up power generation to large on-line power generation applications such as converting large renewable power facilities into dispatchable power plants. This need applies to both single engine and multiple engine applications.

### SUMMARY

These and other needs are addressed by the present disclosure. In a single engine configuration, the present disclosure is directed to dense packaging of turbo-machinery by means of close-coupling of components and by the ability to rotate various engine components with respect to other engine components. In addition, spool shaft rotational direction may be reversed to suit the application. In multiple engine configurations, the same ability to close-couple and rotate components and to reverse shaft rotational direction to rearrange the engine geometry package is used for packaging two or more gas turbine engines to achieve high power density. A key point is that the engines can be dense-packed because of a number of features of the basic engine. The primary features are 1) the use of compact centrifugal compressors and radial inlet turbine assemblies, 2) the close coupling of turbo-machinery for a dense packaging, 3) the ability to rotate certain key components to facilitate ducting and preferred placement of other components, 4) the ability to control spool shaft rotational direction and 5) full power operation at high overall pressure ratios (typically in the range of about 10:1 to about 20:1).

Depending on integration requirements, the turbo-machinery can be packaged to permit access to the different gas streams throughout the cycle for various purposes. For example, a portion of inter-stage flow may be bled for direct use such as cooling of components, bearings etcetera. In another example, a portion of inter-stage flow may be directed to by-pass the recuperator which can be a benefit in engine power-down. The components of the turbine can be interconnected in such a way to preferably position the turbo-machinery adjacent to the required access point for power take-off. By careful selection of turbo-machinery direction of rotation, the orientation of components can be optimized for a given package, installation or integration.

The present disclosure illustrates, for spools comprised of centrifugal compressors and/or radial inlet turbine assemblies, the various flow axes and spool rotation axes in a multi-spool gas turbine engine; how these axes relate to one another; and how components can be rotated about their flow axes to obtain various packaging configurations that may be required in a compact gas turbine engine.

These concepts extend those disclosed in U.S. patent application Ser. No. 13/226,156 entitled “Gas Turbine Engine Configurations”, which is incorporated herein by reference.

In a first embodiment, a gas turbine engine is disclosed comprising: at least first and second turbo-compressor spools, each of the at least first and second turbo-compressor spools comprising a centrifugal compressor in mechanical communication with a corresponding radial inlet turbine, wherein a spool axis of rotation for the centrifugal compressor and radial inlet turbine comprise a common shaft; an intercooler positioned in a fluid path between the first and second centrifugal compressors of the first and second turbo-compressor spools; a recuperator operable to transfer thermal energy from an output gas of a power turbine to a compressed gas produced by the centrifugal compressor of the at least first and second turbo-compressor spools, thereby providing a further heated gas; and a combustor operable to combust a fuel in the presence of the further heated gas, wherein at least one of the following is true: 1) the engine has full power operation at an overall engine compression ratio of about 10:1 to about 20:1; 2) the combustor is substantially contained within a volume occupied by the recuperator; 3) in at least one of the at least first and second turbo-compressor spools, an inflow axis to the centrifugal compressor is in a direction of the spool axis of rotation of the centrifugal compressor while an outflow axis from the centrifugal compressor is at least substantially orthogonal to the spool axis of rotation; 4) in at least one of the at least first and second turbo-compressor spools, an outflow axis from the radial turbine is in a direction of the spool axis of rotation of the radial turbine while an inflow axis to the radial turbine is at least substantially orthogonal to the spool axis of rotation; and 5) in at least one of the at least first and second turbo-compressor spools, opposing flanges connect the centrifugal compressor and corresponding radial turbine, whereby the centrifugal compressor is independently rotatable about the spool axis of rotation relative to the corresponding radial turbine.

In a second embodiment, a gas turbine engine is disclosed comprising: at least first and second turbo-compressor spools, each of the at least first and second turbo-compressor spools comprising a centrifugal compressor in mechanical communication with a radial inlet turbine wherein a spool axis of rotation for the centrifugal compressor and radial inlet turbine comprise a common shaft; an intercooler positioned in a fluid path between the first and second turbo-compressor spools; a recuperator operable to transfer thermal energy from an output gas of a power turbine to a compressed gas produced by the centrifugal compressor of the at least first and second turbo-compressor spools thereby providing a further heated gas; a free power spool comprising a radial inlet turbine and a mechanical power output shaft wherein a spool axis of rotation for the radial inlet turbine and the mechanical power output shaft comprise a common shaft; and a combustor operable to combust a fuel in the presence of the further heated gas, wherein at least one of the following is true: 1) the combustor is substantially contained within a volume occupied by the recuperator; 2) the engine has full power operation at an overall engine compression ratio of about 10:1 to about 20:1; 3) in at least one of the at least first and second turbo-compressor spools, an inflow axis to the centrifugal compressor is in a direction of the spool axis of rotation of the centrifugal compressor while an outflow axis from the centrifugal compressor is at least substantially orthogonal to the spool axis of rotation; 4) in at least one of the at least first and second turbo-compressor spools turbo-compressor spools, an outflow axis from the radial turbine is in a direction of the spool axis of rotation of the radial turbine while an inflow axis to the radial turbine is at least substantially orthogonal to the spool axis of rotation; 5) in at least one of the at least first and second turbo-compressor spools turbo-compressor spools, opposing flanges connect the centrifugal compressor and corresponding radial turbine, whereby the centrifugal compressor is independently rotatable about the spool axis of rotation relative to the corresponding radial turbine; and 6) the free power turbine having an inflow axis at least substantially orthogonal to a power output shaft axis of rotation and an outflow axis at least substantially parallel to the power output shaft axis of rotation.

These and other advantages will be apparent from the disclosures contained herein.

The above-described embodiments and configurations are neither complete nor exhaustive. As will be appreciated, other embodiments of the disclosure are possible utilizing, alone or in combination, one or more of the features set forth above or described in detail below.

The following definitions are used herein:

The phrases at least one, one or more, and and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The Brayton cycle is a thermodynamic cycle that describes the workings of the gas turbine engine. It is named after George Brayton, the American engineer who developed it. It is also sometimes known as the Joule cycle. The ideal Brayton cycle consists of an isentropic compression process followed by an isobaric combustion process where fuel is burned, then an isentropic expansion process where the energized fluid gives up its energy to operate compressors or produce engine power and lastly an isobaric process where low grade heat is rejected to the atmosphere. An actual Brayton cycle consists of an adiabatic compression process followed by an isobaric combustion process where fuel is burned, then an adiabatic expansion process where the energized fluid gives up its energy to operate compressors or produce engine power and lastly an isobaric process where low grade heat is rejected to the atmosphere. A ceramic is an inorganic, nonmetallic solid prepared by the action of heating and cooling. Ceramic materials may have a crystalline or partly crystalline structure, or may be amorphous (e.g., a glass).

The terms determine, calculate and compute and variations thereof are used interchangeably and include any type of methodology, process, mathematical operation or technique.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power is the principal mechanical output power shaft. A free power turbine is not connected to a compressor in the gasifier section, although the free power turbine may be in the gasifier section of the gas turbine engine. A power turbine may also be connected to a compressor in the gasifier section in addition to providing rotary power to an output power shaft.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A gasifier is a turbine-driven compressor in a gas turbine engine dedicated to compressing air that, once heated, is expanded through a free power turbine to produce

A heat exchanger is a device that allows heat energy from a hotter fluid to be transferred to a cooler fluid without the hotter fluid and cooler fluid coming in contact. The two fluids are typically separated from each other by a solid material such as a metal, that has a high thermal conductivity.

An intercooler as used herein means a heat exchanger positioned between the output of a compressor of a gas turbine engine and the input to a higher pressure compressor of a gas turbine engine. Air, or in some configurations, an air-fuel mix is introduced into a gas turbine engine and its pressure is increased by passing through at least one compressor. The working fluid of the gas turbine then passes through the hot side of the intercooler and heat is removed typically by an ambient fluid such as, for example, air or water flowing through the cold side of the intercooler.

The term means shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

A metallic material is a material containing a metal or a metallic compound. A metal refers commonly to alkali metals, alkaline-earth metals, radioactive and non-radioactive rare earth metals, transition metals, and other metals.

A prime power source refers to any device that uses energy to develop mechanical or electrical power, such as motion in some other machine. Examples are diesel engines, gas turbine engines, microturbines, Stirling engines, spark ignition engines and fuel cells.

Power density as used herein is power per unit volume (watts per cubic meter).

A recuperator is a heat exchanger dedicated to returning exhaust heat energy from a process back into the process to increase process efficiency. In a gas turbine thermodynamic cycle, heat energy is transferred from the turbine discharge to the combustor inlet gas stream, thereby reducing heating required by fuel to achieve a requisite firing temperature.

A regenerator is a type of heat exchanger where the flow through the heat exchanger is cyclical and periodically changes direction. It is similar to a countercurrent heat exchanger. However, a regenerator mixes a portion of the two fluid flows while a countercurrent exchanger maintains them separated. The exhaust gas trapped in the regenerator is mixed with the trapped air later. It is the trapped gases that get mixed, not the flowing gases, unless there are leaks past the valves.

Regenerative braking is the same as dynamic braking except the electrical energy generated is captured in an energy storage system for future use.

Specific power as used herein is power per unit mass (watts per kilogram).

Spool refers to a group of turbo-machinery components on a common shaft.

Spool speed as used herein means spool shaft rotational speed which is typically expressed in revolutions per minute (“rpms”). As used herein, spool rpms and spool speed may be used interchangeably.

A thermal energy storage module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth combustion process as the flow down the channels is effectively one-dimensional fully developed flow with a marked absence of hot spots.

A thermal reactor, as used herein, is another name for a thermal oxidizer.

A turbine is a rotary machine in which mechanical work is continuously extracted from a moving fluid by expanding the fluid from a higher pressure to a lower pressure. The simplest turbines have one moving part, a rotor assembly, which is a shaft or drum with blades attached. Moving fluid acts on the blades, or the blades react to the flow, so that they move and impart rotational energy to the rotor.

Turbine Inlet Temperature (TIT) as used herein refers to the gas temperature at the outlet of the combustor which is closely connected to the inlet of the high pressure turbine and these are generally taken to be the same temperature.

Turbocharger-like architecture or turbocharger technology means spools which are derived from modified stock turbo-charger hardware components. In an engine where a centrifugal turbine with a ceramic rotor is used, the tip speed of the rotor is held to a proven allowable low limit (<500 m/s). Centrifugal compressors and radial inlet turbines are typically used in turbo-charger applications.

A turbo-compressor spool assembly as used herein refers to an assembly typically comprised of an outer case, a centrifugal compressor, a radial inlet turbine wherein the centrifugal compressor and radial inlet turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

A volute is a scroll transition duct which looks like a tuba or a snail shell. Volutes may be used to channel flow gases from one component of a gas turbine to the next. Gases flow through the helical body of the scroll and are redirected into the next component. A key advantage of the scroll is that the device inherently provides a constant flow angle at the inlet and outlet. To date, this type of transition duct has only been successfully used on small engines or turbo-chargers where the geometrical fabrication issues are less involved.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals refer to like or analogous components throughout the several views.

FIG. 1 is depicts a prior art turbo-machine composed of three independent spools, two nested turbo-compressor spools and one free turbine spool connected to a load device.

FIG. 2 illustrates a prior art integrated spool motor/generator showing generators on both low pressure and high pressure spools.

FIG. 3 shows a prior art high-efficiency multi-spool engine configuration with two stages of intercooling and reheat.

FIG. 4 shows a turbo-compressor spool assembly.

FIG. 5 shows a free power spool assembly.

FIG. 6 shows a multi spool assembly.

FIG. 7 shows a configuration of spools.

FIG. 8 shows an alternate configuration of spools.

FIG. 9 shows compressor and turbine axes conventions.

FIG. 10 shows a gas turbine engine configuration.

### DETAILED DESCRIPTION

### Multi-Spool Gas Turbine Architectures

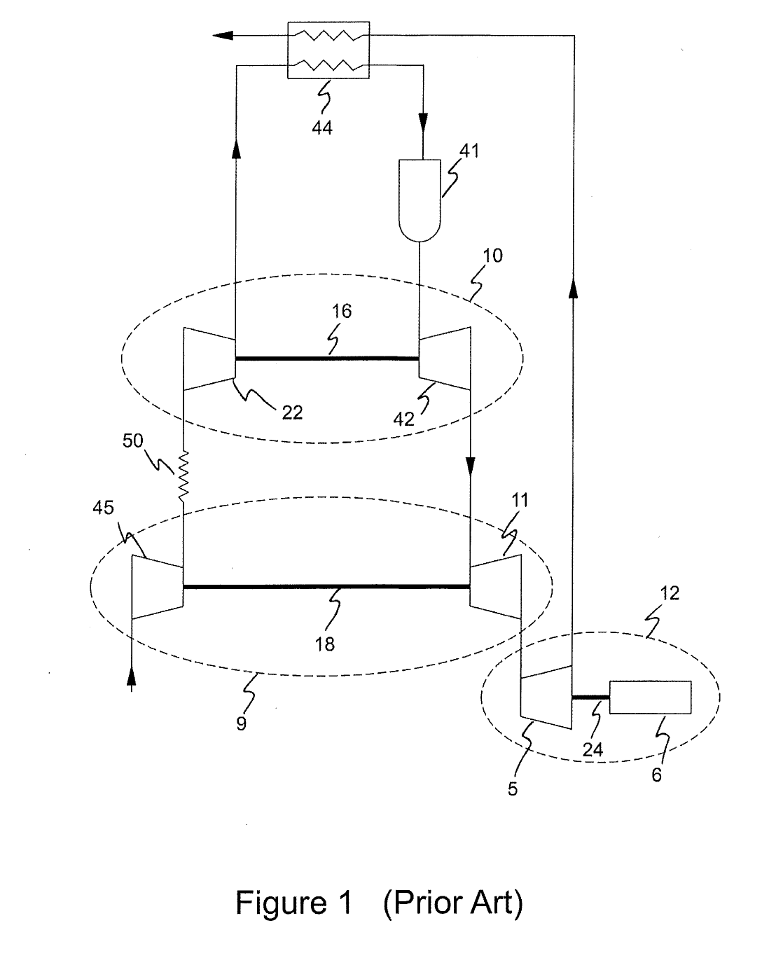

FIG. 1 illustrates a prior art turbo-machine comprised of three independent spools. Two are nested turbo-compressor spools and one is a free power turbine spool connected to a load device. A conventional gas turbine may be comprised of two or more turbo-compressor spools to achieve a progressively higher pressure ratio. A turbo-machine composed of three independent rotating assemblies or spools, including a high pressure turbo-compressor spool 10, a low pressure turbo-compressor spool 9, and a free power turbine spool 12 appears in FIG. 1. As seen in FIG. 1, the high pressure spool 10 is comprised of a compressor 22, a turbine 42, and a shaft 16 connecting the two. The low pressure spool 9 is comprised of a compressor 45, a turbine 11, and a shaft 18 connecting the two. The free power turbine spool 12 is comprised of a turbine 5, a load device 6, and a shaft 24 connecting the two. The load device is typically a generator or a transmission/drive train or a combination of both (for example a hybrid vehicle transmission). The load device 6 may have a gear box (not shown) connecting the output power shaft 24 to load 6. A combustor 41 is used to combust fuel and further heat the air between a recuperator 44 and high pressure turbine 42. In operation, gas is ingested into a low pressure compressor 45. The outlet of the low pressure compressor 45 passes through an intercooler 50 which removes a portion of heat from the gas stream at approximately constant pressure. The gas then enters a high pressure compressor 22. The outlet of high pressure compressor 22 passes through the cold side of a recuperator 44 where a portion of heat from the exhaust gas is transferred, at approximately constant pressure, to the gas flow from the high pressure compressor 22. The further heated gas from the cold side of recuperator 44 is then directed to a combustor 41 where a fuel is burned, adding heat energy to the gas flow at approximately constant pressure. The gas emerging from the combustor 41 then enters a high pressure turbine 42 where work is done by turbine 42 to operate high pressure compressor 22. The gas from the high pressure turbine 42 then drives low pressure turbine 11 where work is done by turbine 11 to operate low pressure compressor 45. The gas exiting from low pressure turbine 11 then drives a free power turbine 5. The shaft of free power turbine 5, in turn, drives a load 6 which may be, for example, a transmission for a vehicle or an electrical generator. Finally, the gas exiting free power turbine 5 flows through the hot side of the recuperator 44 where heat is extracted and used to preheat the gas just prior to entering the combustor. The gas exiting the hot side of the recuperator is then exhausted to the atmosphere. This engine configuration is discussed in U.S. patent application Ser. No. 12/115,134 entitled “Multi-Spool Intercooled Recuperated Gas Turbine”and in U.S. patent application Ser. No. 13/175,564, entitled “Improved Multi-Spool Intercooled Recuperated Gas Turbine”, both of which are incorporated herein by reference.

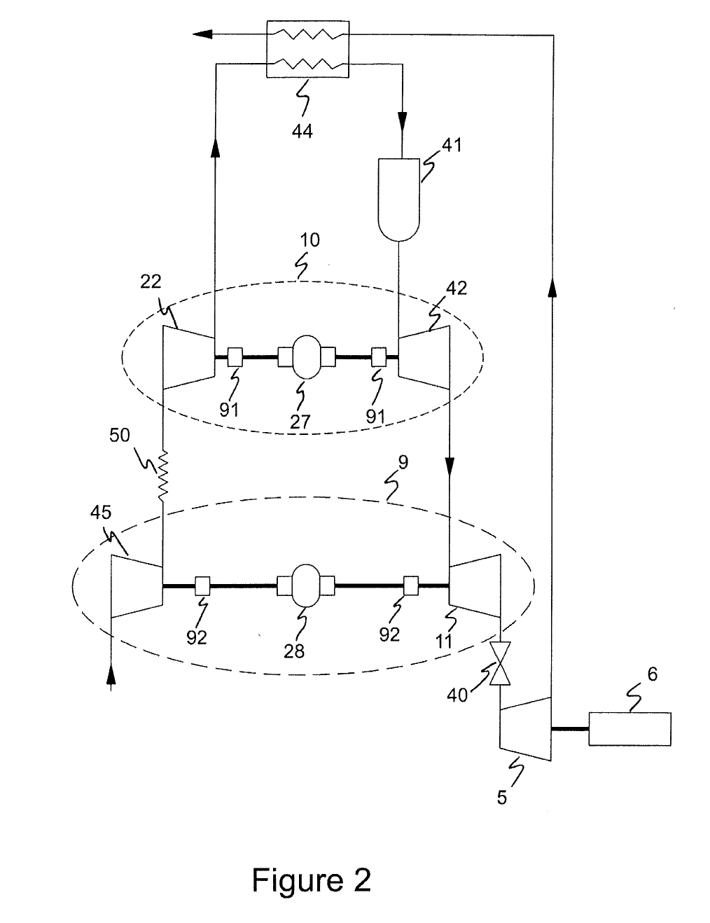

FIG. 2 illustrates a previously disclosed electric motor/generator combination integrated into both low pressure and high pressure spools. A first compact shaft-speed motor/generator 27, supported by its main bearings 97, is shown on turbo-compressor spool 10. A second compact shaft-speed motor/generator 28, supported by its main bearings 92, is also shown on turbo-compressor spool 9. The sizes of generators 27 and 28 are relatively small and each is capable of adding or extracting a small amount of power (for example, each is capable of adding or extracting about 10% or less of the full power output of the engine) during engine operation.

It should also be noted that it is possible to include a clutch mechanism with the integrated spool motor/generators on both low pressure and high pressure turbo-compressor spools so that, when the engine is operating at a selected power level, one or both motor/generators can be disengaged from the shafts to reduce the parasitic load of the spinning motor/generators.

This engine configuration is discussed in U.S. patent application Ser. No. 12/115,134 entitled “Multi-Spool Intercooled Recuperated Gas Turbine” and in U.S. patent application Ser. No. 13/175,564, entitled “Improved Multi-spool Intercooled Recuperated Gas Turbine”.

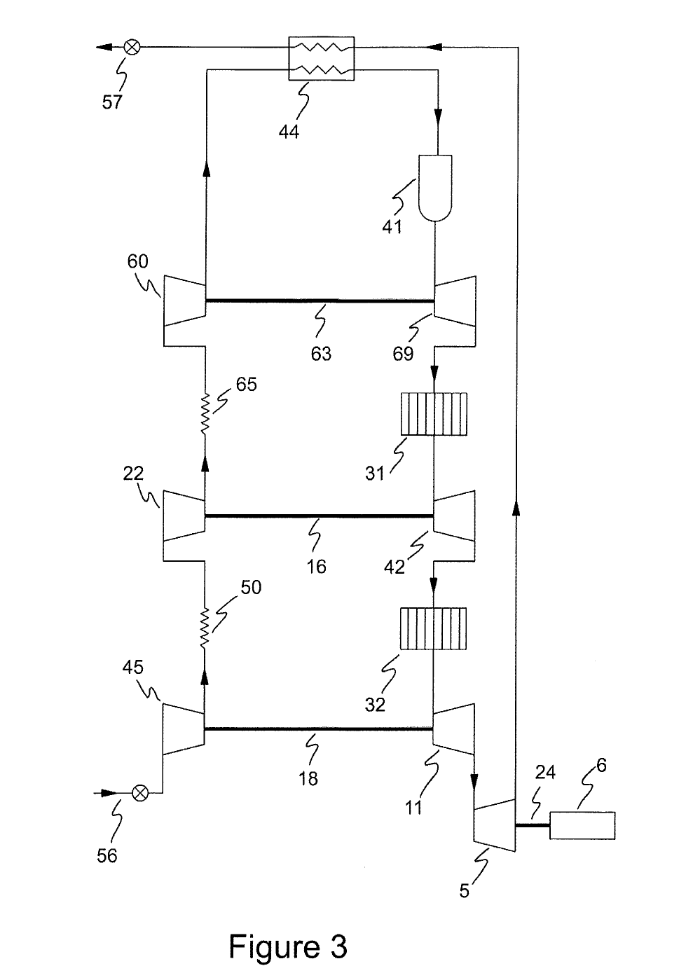

FIG. 3 shows a previously disclosed high-efficiency multi-spool engine configuration with two stages of intercooling and reheat. FIG. 3 shows an architecture for a gas turbine with multiple heat rejections and additions with shaft power being delivered by a free power turbine. The working fluid (typically air) is ingested at inlet 56 and fed to compressor 45. Heat is extracted by a first intercooler 50 and then the working fluid is delivered to compressor 22. Additional heat is extracted by a second intercooler 65 and then the working fluid is delivered to compressor 60. The output of compressor 60 is input into the cold side of recuperator 44 where heat from the exhaust stream is added. The working fluid is then introduced along with fuel to combustor 41 which burns the fuel and brings the fully diluted combustion products at approximately constant pressure to their maximum temperature. The combustion products are expanded through turbine 69 which powers compressor 60. The output of turbine 69 is then passed through a first thermal reactor 31 which adds and combusts additional fuel to generate additional heat at approximately constant pressure. The flow then enters turbine 42 where it is expanded through turbine 42 which powers compressor 22. The output of turbine 42 is then passed through a second thermal reactor 32 which adds and combusts additional fuel at approximately constant pressure to generate additional heat to the combustion products. The flow then enters turbine 11 where it is expanded through turbine 11 which powers compressor 45. The output of turbine 11 then enters free power turbine 5 which rotates shaft 24 which in turn delivers mechanical power to load 6. The working gas output of free power turbine 5 is then passed through the hot side of recuperator 44 where heat is extracted and used to heat the flow that is about to enter the combustor 41. The flow from the hot side of recuperator 44 is then exhausted to the atmosphere 57.

This engine concept is disclosed in U.S. Patent Application Serial No. 13/534,909 entitled “High Efficiency Compact Gas Turbine” Engine, which is incorporated herein by reference.

### Gas Turbine Engine Using Centrifugal Compressors and Radial Inlet Turbines

In the present disclosure, an important point is that the engines can be dense-packed because of a number of features of the basic engine when centrifugal compressors and radial inlet turbines are used. The primary features are 1) the use of compact centrifugal compressors and radial inlet turbine assemblies, 2) the close coupling of turbo-machinery for a dense packaging, 3) the ability to rotate certain key components to facilitate ducting and preferred placement of other components, 4) the ability to control spool shaft rotational direction and 5) full power operation at high overall pressure ratios (typically in the range of about 10:1 to about 20:1). These features can be utilized to dense pack single or multiple engines.

The basic engine used herein to illustrate packing is an approximately 375 kW gas turbine engine. As can be appreciated, the same packing principles can be applied to gas turbine engines in the power range of about 10 kW to about 1,000 kW.

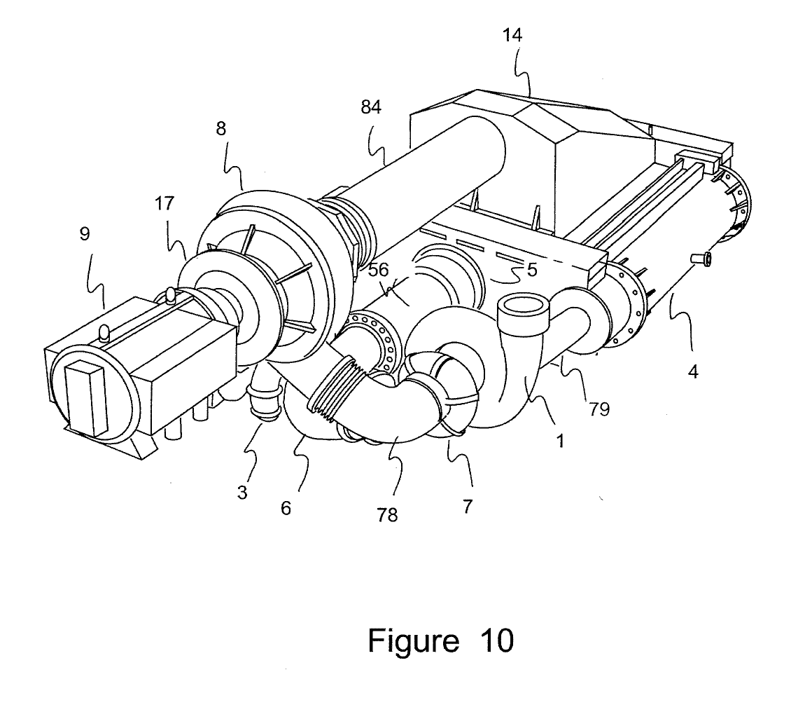

The features that allow dense packing include:
the use of compact centrifugal compressors and radial inlet turbine assemblies
full power operation at a high compression ratio of about 10:1 to about 20:1 which permits the use of smaller components to achieve the desired mass flow rate. It is noted that there is an optimum pressure ratio for maximum engine efficiency. For pressure ratios higher than the optimum pressure ratio, engine efficiency falls off slowly with increasing pressure while engine size is reduced almost directly with increasing pressure. Trading off a few percent of engine efficiency for a substantial reduction of engine size is a positive tradeoff when a reduction in engine weight and volume are important.
an innovative compact recuperator design which is typically a large component in prior art gas turbines. Such a recuperator design is described in U.S. patent application Ser. No. 12/115,069 entitled, “Heat Exchange Device and Method for Manufacture” and U.S. patent application Ser. No. 12/115,219 entitled “Heat Exchanger with Pressure and Thermal Strain Management”, both of which are incorporated herein by reference. These recuperators can be operated at temperatures up to about 1,000 K and pressure differentials of about 10:1 to about 20:1 where the pressure differential is between the hot and cold sides of the recuperator.
nesting the combustor substantially within the recuperator assembly
all three turbo-machinery modules or spools (typically a turbo-compressor spool is a spool comprised of a compressor and a turbine connected by a shaft. A free power turbine spool is a spool comprised of a turbine and a turbine power output shaft) are arranged so that they can be connected with a minimum of ducting so that the overall engine is very compact.
the ability to rotate the compressor and turbine independently on a turbo-compressor spool. For example, the inlet flow to a centrifugal compressor is along a flow axis that is coincident with the axis of rotation of the spool while the output flow is through a volute/diffuser which is at right angles to the axis of rotation. The volute/diffuser can be rotated about its outflow axis to direct the output flow in any desired direction in the plane that is orthogonal to the axis of rotation of the spool. For example, the outlet flow from a radial inlet turbine is in the direction of its flow axis while the input flow is thru a volute/scroll which is at right angles to the axis of rotation and which can be rotated about the axis to receive the input flow from any desired direction.
the ability to control spool shaft rotational direction by changing the rotors in the spools turbine and, if used, the spool's compressor.
centrifugal compressors and radial inlet turbine assemblies allow the use of curved ducting that in turn facilitates placement of other components. This is illustrated in the engine depicted in FIG. 10.

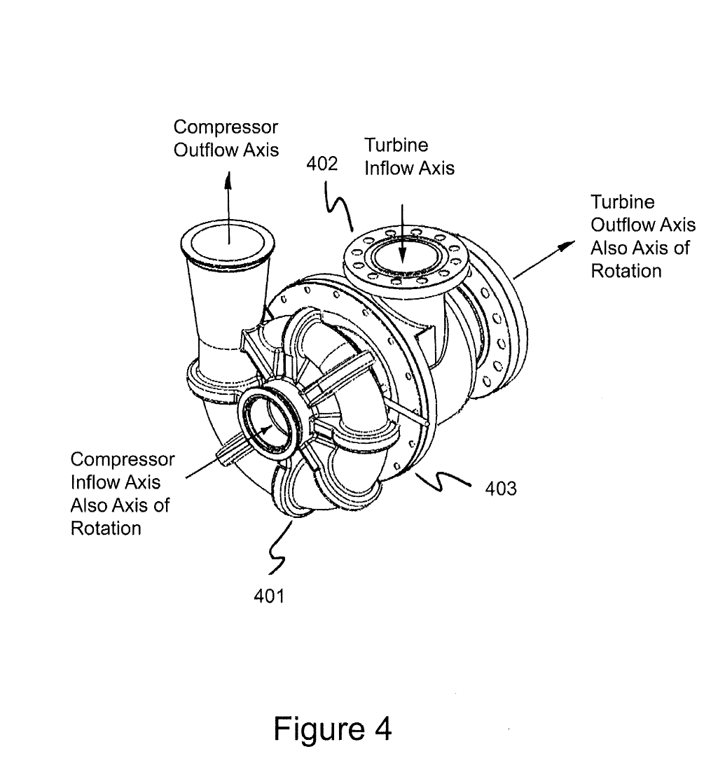

FIG. 4 shows a previously disclosed turbo-compressor spool assembly which is comprised of a centrifugal compressor 401 and a radial inlet turbine 402 on a common shaft. The common shaft is the axis of rotation. The axis of rotation is also the inflow axis of compressor 401 as well as the outflow axis of turbine 402. As can be seen in this example, the outflow axis of compressor 401 is in a plane that is orthogonal to the axis of rotation of the spool and the inflow axis of turbine 402 is also in the same plane that is orthogonal to the axis of rotation of the spool. As can also be seen, the inflow axis of compressor 401 and the outflow axis of turbine 402 can be fixed at any angle in a plane orthogonal to the axis of rotation of the spool with respect to each other, by rotating the compressor about the axis of rotation with respect to the turbine. As shown in FIG. 4, changing the relative angle is accomplished by un-bolting the coupling flange 403, rotating compressor 401 relative to turbine 402, and then re-bolting the flange 403. As can be appreciated, a coupling flange that can provide a continuously varying angle can be used rather than the bolted coupling flange 403 shown which can only provide a limited number of discrete angles of rotation as dictated by the bolt pattern.

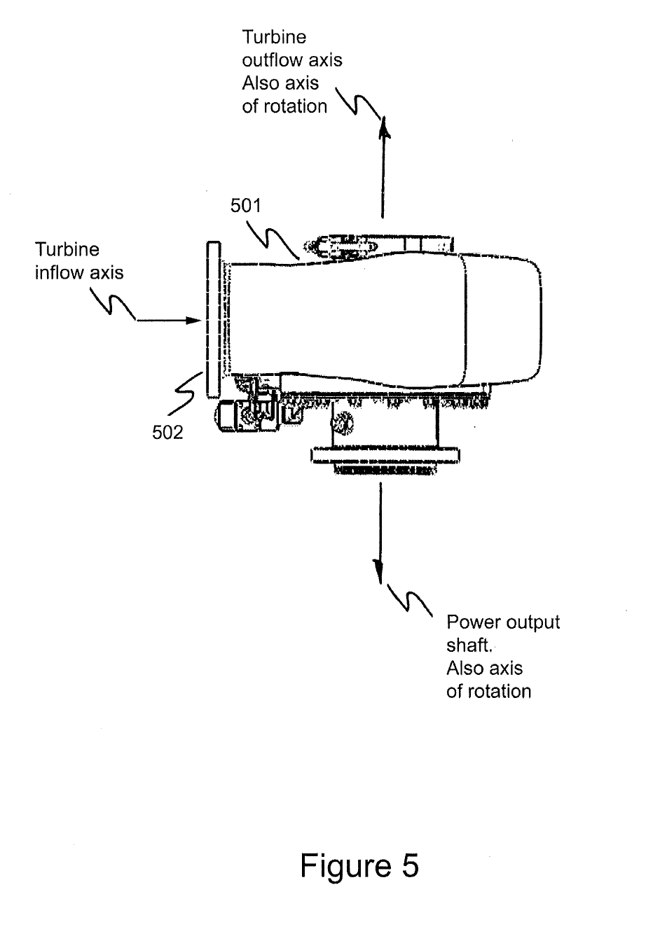

FIG. 5 shows a previously disclosed top view of a free power spool assembly. The free power turbine is a radial inlet turbine. The free power spool 501 has no compressor, only a turbine which rotates a mechanical power output shaft. The turbine outflow axis and the power output shaft are on a common shaft. The common shaft is also the axis of rotation. The turbine inflow axis is orthogonal to the axis of rotation. The free power turbine assembly 501 is connected to other components of the gas turbine engine via flange 502. As can also be seen, the inflow axis of the turbine can be fixed at any angle with respect to the component to which it is attached. This can be accomplished by un-bolting the coupling flange 502, rotating the free power turbine assembly 501 relative to the component to which it is attached. As can be appreciated, a coupling flange that can provide a continuously varying angle can be used rather than the bolted coupling flange 502 shown which can only provide a limited number of discrete angles of rotation as dictated by the bolt pattern. Rotating the free power turbine about its inflow axis also rotates the axis of rotation of the free power turbine and therefore rotates the direction of the turbine outflow as well as the power output shaft. In the engine architectures of FIGS. 1, 2 and 3, a low pressure turbine outflow is connected to the free power turbine inflow. In these architectures, the free power turbine outflow is connected to a duct leading to the hot side of a recuperator.

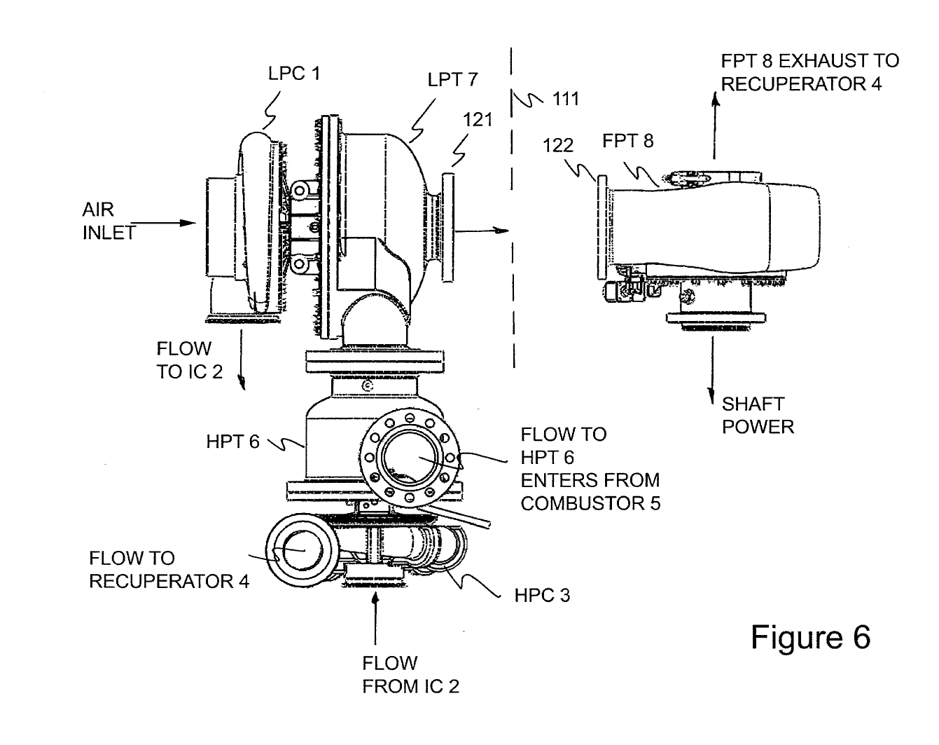

FIG. 6 is a previously disclosed plan view illustrating showing two turbo-compressor spools and a free power spool. For illustration, the free power spool is shown disconnected from the two turbo-compressor spools. The working fluid (air or, in some engine configurations, an air-fuel mixture) enters low pressure compressor 1 and the resulting compressed flow is sent to an intercooler (not shown in this figure but illustrated in FIG. 1 as component 2). Gas flow from the intercooler enters high pressure compressor 3 and the resulting further compressed flow is sent to the cold side of a recuperator (not shown in this figure but illustrated in FIG. 1 as component 44). Flow from a combustor (not shown as it is typically embedded within recuperator 44) enters high pressure turbine 6, is expanded and sent to low pressure turbine 7 where it is further expanded and delivered to free power turbine 8. In this engine configuration, free power turbine 8 provides the primary mechanical shaft power from the engine. The flow from free power turbine 8 is typically sent to the hot side of the recuperator (not shown in this figure but illustrated in FIG. 1 as component 44). The connection points between the gasifier components and load module (which typically includes the free power turbine) may be at location 111 between the low pressure turbine 7 outlet and free power turbine 8 input and at location 112 between free power turbine 8 outlet and a duct leading to the hot side inlet of the recuperator. As can be appreciated, the connection points between the engine module and load module may be at different locations, such as for example between the high pressure turbine outlet and the low pressure turbine inlet and between the free power turbine outlet and a duct leading to recuperator inlet.

As can be further appreciated, the two turbo-compressor spools can be rotated relative to each other and to the free power turbine spool as described in FIGS. 4 and 5.

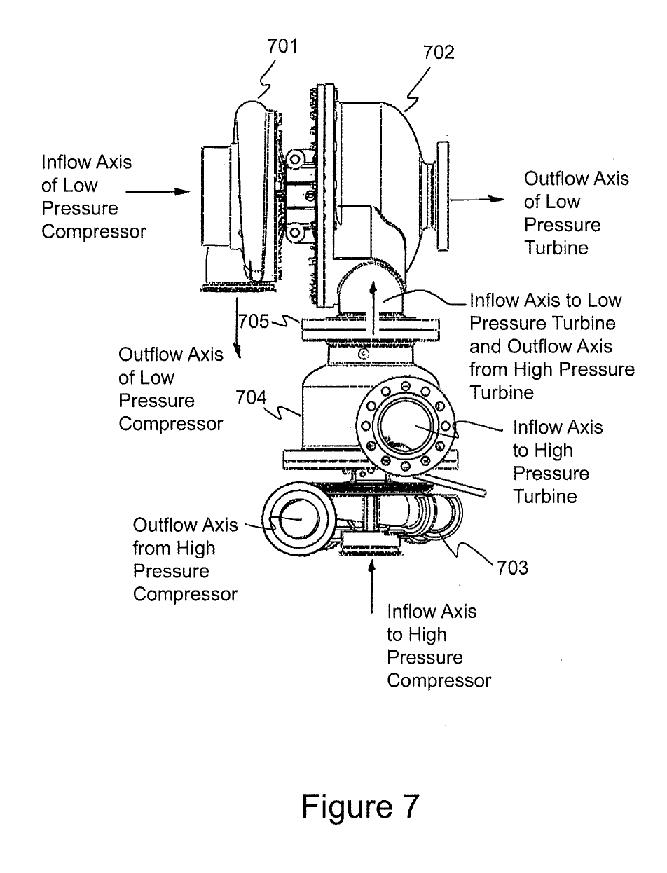

FIG. 7 is a previously disclosed plan view illustrating various gas turbine engine components of a two spool assembly. The working fluid (air or, in some engine configurations, an air-fuel mixture) enters low pressure compressor 701 and the resulting compressed flow is sent to an intercooler (not shown in this figure but illustrated in Figure las component 50). Flow from the intercooler enters high pressure compressor 703 and the resulting further compressed flow is sent to the cold side of a recuperator (not shown in this figure but illustrated in FIG. 1 as component 44). Flow from a combustor (not shown as it is typically embedded within recuperator 44) enters high pressure turbine 704 is expanded and sent to low pressure turbine 702 where it is further expanded and delivered to a free power turbine (not shown). The outflow axis of low pressure compressor 701 is shown exiting downward on the page. The outflow axis from the high pressure compressor 703 is shown entering from the front of the page. The inflow axis of the high pressure turbine 704 is also shown entering from the front of the page.

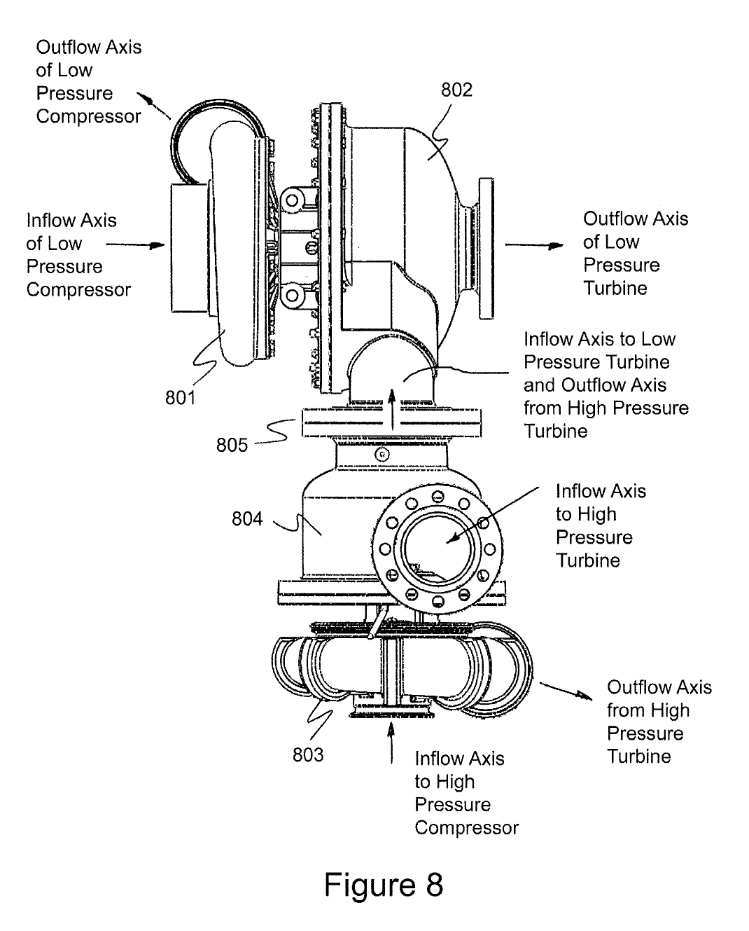

FIG. 8 is a previously disclosed plan view illustrating an alternate arrangement of various gas turbine engine components of a two spool assembly shown in FIG. 7. The working fluid (air or, in some engine configurations, an air-fuel mixture) enters low pressure compressor 801 and the resulting compressed flow is sent to an intercooler (not shown in this figure but illustrated in Figure las component 50). Flow from the intercooler enters high pressure compressor 803 and the resulting further compressed flow is sent to the cold side of a recuperator (not shown in this figure but illustrated in FIG. 1 as component 44). Flow from a combustor (not shown as it is typically embedded within recuperator 44) enters high pressure turbine 804 is expanded and sent to low pressure turbine 802 where it is further expanded and delivered to a free power turbine (not shown). The outflow axis of low pressure compressor 801 is shown exiting to the back of the page. The outflow axis from the high pressure compressor 803 is shown exiting to the back to the back of the page. The inflow axis of the low pressure compressor 801 is shown entering from the left of the page and high pressure turbine 704 is shown entering from the bottom of the page.

### Axes Conventions

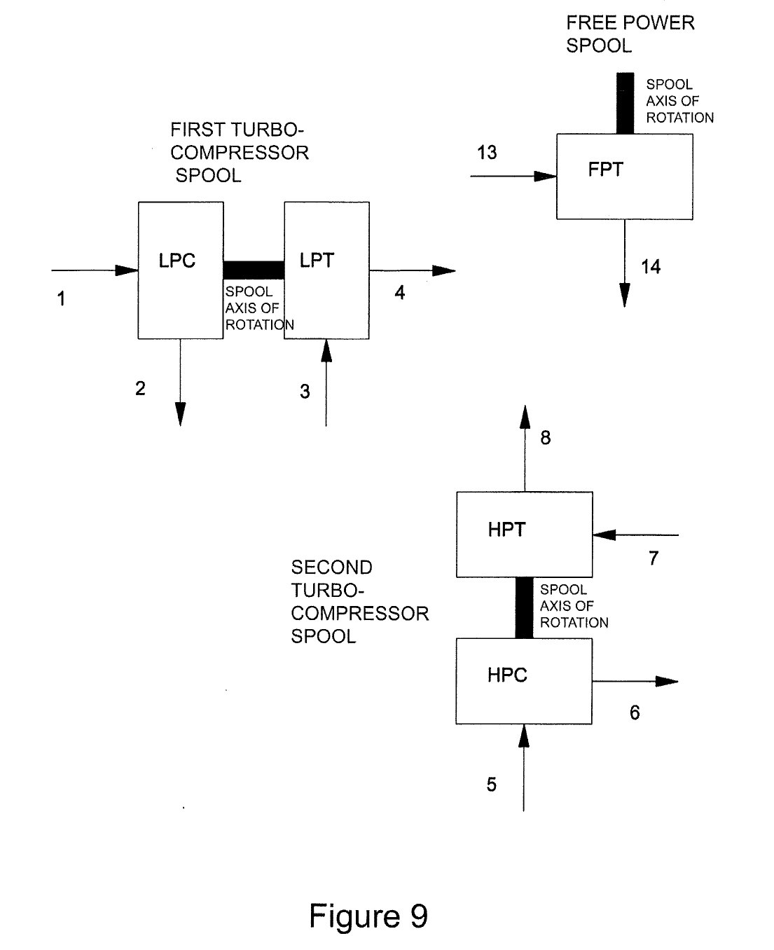

FIG. 9 shows centrifugal compressor and radial inlet turbine axes conventions used herein. As used herein, transverse means “not parallel”. A spool axis is the axis of rotation of the shaft connecting a compressor rotor and turbine rotor which are commonly mounted on the same a shaft. Therefore the axis of rotation of a centrifugal compressor inlet is the same axis of rotation as its corresponding radial inlet turbine outlet. A flow axis may be the direction of the inflow of a centrifugal compressor; outlet flow of a centrifugal compressor; inlet flow to a radial inlet turbine; or outflow from a radial turbine. On any turbo-compressor spool, the flow axis of the outlet flow of a centrifugal compressor and the flow axis of the inlet flow to a radial inlet turbine are in a plane that is orthogonal to the axis of rotation of the spool. Since the compressor outlet flow axis and corresponding radial turbine inlet flow axis can be aligned independently, they can be at any angle with respect to each other but always remain in a plane which is orthogonal to the spool axis of rotation. The compressor outlet flow axis and corresponding radial turbine inlet flow axis may be parallel but in general they are transverse to each other. They may be in the same plane but in general they are not in the same plane but always in a plane which is orthogonal to the spool axis of rotation.

In a multi-spool gas turbine engine using centrifugal compressors and radial inlet turbines on a spool (called a turbo-compressor spool), the spool axes of rotation of adjacent spools are typically orthogonal. However they may be ± about 15 degrees from orthogonal to facilitate packaging. When the spool axes of rotation are within ± about 15 degrees from orthogonal, they are assumed to be “substantially orthogonal”.

For a first and second turbo-compressor spool, the following conventions are used:
the first flow axis is along the direction of flow into the compressor of the first turbo-compressor spool and is coincident with the spool axis of rotation of the first turbo-compressor spool.
the second flow axis is along the direction of flow out of the compressor of the first turbo-compressor spool and is in a plane that is orthogonal to the spool axis of rotation of the first turbo-compressor spool,
the third flow axis is along the direction of flow into the turbine of the first turbo-compressor spool and is in a plane that is orthogonal to the spool axis of rotation of the first turbo-compressor spool. The third flow axis need not be in the same orthogonal plane as the second flow axis.
the fourth flow axis is along the direction of flow out of the turbine of the first turbo-compressor spool and is coincident with the spool axis of rotation of the first turbo-compressor spool.
the fifth flow axis is along the direction of flow into the compressor of the second turbo-compressor spool and is coincident with the spool axis of rotation of the second turbo-compressor spool.
the sixth flow axis is along the direction of flow out of the compressor of the second turbo-compressor spool and is in the plane that is orthogonal to the spool axis of rotation of the second turbo-compressor spool.
the seventh flow axis is along the direction of flow into the turbine of the second turbo-compressor spool and is in the plane that is orthogonal to the spool axis of rotation of the second turbo-compressor spool. The sixth flow axis need not be in the same orthogonal plane as the seventh flow axis.
the eighth flow axis is along the direction of flow out of the turbine of the second turbo-compressor spool and is coincident with of the spool axis of rotation of the second turbo-compressor spool.
the thirteenth flow axis is along the direction of flow into the free power turbine of the free power spool.
the fourteenth flow axis is along the direction of flow out of the free power turbine of the free power spool and is coincident with the spool axis of rotation of the free power spool

The ninth, tenth, eleventh and twelfth flow axes are reserved for a third turbo-compressor spool.

The spool axes of rotation are as follows:
the first turbo-compressor has a spool axis of rotation that is coincident with the first and fourth flow axis
the second turbo-compressor has a spool axis of rotation that is coincident with the fifth and eighth flow axis
a third turbo-compressor would have a spool axis of rotation that is coincident with the ninth and twelfth flow axis
the free power turbine has a spool axis of rotation that is coincident with the mechanical power output shaft

In general, the following relations pertain:
the first and fourth flow axes are coincident with the spool axis of rotation of the first turbo-compressor spool
the fifth and eighth flow axes are coincident with the spool axis of rotation of the second turbo-compressor spool
the first, second, fifth and sixth axes are compressor flow axes
the third, fourth, seventh and eighth axes are turbine flow axes
flow axes 1 and 4 are along the same axis and their flow is in the same direction
flow axes 5 and 8 are along the same axis and their flow is in the same direction
flow axes 2 and 3 are in a plane that is orthogonal to the low pressure spool axis of rotation and their flow axes are usually transverse but can be parallel
flow axes 6 and 7 are in a plane that is orthogonal to the high pressure spool axis of rotation and their flow axes are usually transverse but can be parallel

### Example of a Compact 500 HP Gas Turbine Engine

FIG. 10 is a previously disclosed rendering of a gas turbine engine configured for a vehicle. This engine configuration is based on the architecture shown in FIG. 1. This figure shows a load device 9, such as for example a high speed alternator, attached via a reducing gearbox 17 to the output shaft of a radial inlet free power turbine 8. A cylindrical duct 84 delivers the exhaust from free power turbine 8 to plenum 14 which feeds the hot side of recuperator 4. A low pressure centrifugal compressor receives its inlet air via a duct (not shown) and sends compressed inlet flow to an intercooler (also not shown) via duct outlet 1. The flow from the intercooler is sent via a duct (not shown) to the inlet of high pressure centrifugal compressor 6 which is partially visible underneath radial inlet free power turbine 8. The compressed flow from high pressure compressor scroll 3 is split into two ducts 79 and delivered to the cold side of recuperator 4 and then to a combustor which is contained within a hot air pipe inside recuperator 4. The flow from combustor 5 (whose outlet end is just visible) is delivered to high pressure radial inlet turbine 6 via cylindrical duct 56. The flow from high pressure turbine 6 is directed through low pressure turbine 7. The expanded flow from low pressure turbine 7 is then delivered to free power turbine 8 via a duct 78 which includes a 90 degree elbow. The elbow allows the recuperator assembly to be placed in an orientation that results in a relatively flat engine profile suitable for a vehicle. Recuperator 4 is a three hole recuperator such as described in U.S. patent application Ser. No. 12/115,219 entitled “Heat Exchanger with Pressure and Thermal Strain Management”. Recuperator 4 can also be a two hole recuperator such as described in U.S. patent application Ser. No. 12/115,069 entitled “Heat Exchange Device and Method for Manufacture”.

This engine has a relatively flat efficiency curve over wide operating range. It also has a multi-fuel capability with the ability to change fuels on the fly as described in U.S. patent application Ser. No. 13/090,104 entitled “Multi-Fuel Vehicle Strategy” which is incorporated herein by reference.

For example, in a large Class 8 truck application, the ability to close couple turbomachinery components can lead to the following benefits. Parts of the engine can be modular so components can be positioned throughout vehicle. The low aspect ratio and low frontal area of components such as the spools, intercooler and recuperator facilitates aerodynamic styling. The turbocharger-like components have the advantage of being familiar to mechanics who do maintenance. It can also be appreciated that the modularity of the components leads to easier maintenance by increased access and module replacement. Strategies for replacement based on simple measurements filtered by algorithms can be used to optimize maintenance strategies. These strategies could be driven by cost or efficiency. In a Class 8 truck chassis, the components can all be fitted between the main structural rails of the chassis so that the gas turbine engine occupies less space than a diesel engine of comparable power rating. This reduced size and installation flexibility facilitate retrofit and maintenance. This installation flexibility also permits the inclusion of an integrated generator/motor on either or both of the low and high pressure spools such as described in U.S. patent application Ser. No. 13/175,564, entitled “Improved Multi-Spool Intercooled Recuperated Gas Turbine”. This installation flexibility also enables use of direct drive or hybrid drive transmission options.

### Temperature Control of Radial Inlet Turbine Rotors

High gas turbine engine efficiencies can be obtained by increasing the outlet temperature of the combustion products emerging from the combustor. At some temperature level, the rotor of the turbine that receives the outlet gases from the combustor will exceed the temperature that will cause deformation or melting of solid metallic turbine rotor blades and other metallic turbine components. The outlet temperature of the combustion products can be increased beyond this limit by replacing some or all of the metallic turbine components with ceramic components. This is discussed in U.S. patent application Ser. No. 13/180,275 entitled “Metallic Ceramic Spool for a Gas Turbine Engine” and in U.S. patent application Ser. No. 13/476,754 entitled “Ceramic-to-Metal Turbine Shaft Attachment” both of which are incorporated herein by reference.

It is also possible to increase the outlet temperature of the combustion products beyond this limit using metallic turbine rotor blades even on small turbine rotors by using active cooling techniques. These are discussed in U.S. Provisional Application No. 61/596563 entitled “Active Cooling System for a Radial In-Flow Turbine” which is also incorporated herein by reference.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A gas turbine engine, comprising:
at least first and second turbo-compressor spools, each of the at least first and second turbo-compressor spools comprising a centrifugal compressor in mechanical communication with a corresponding radial inlet turbine, wherein a spool axis of rotation for the centrifugal compressor and radial inlet turbine comprise a common shaft;
an intercooler positioned in a fluid path between the first and second centrifugal compressors of the first and second turbo-compressor spools;
a recuperator operable to transfer thermal energy from an output gas of a power turbine to a compressed gas produced by the centrifugal compressor of the at least first and second turbo-compressor spools, thereby providing a further heated gas; and
a combustor operable to combust a fuel in the presence of the further heated gas, wherein at least one of the following is true:
(i) the engine has full power operation at an overall engine compression ratio of about 10:1 to about 20:1;
(ii) the combustor is substantially contained within a volume occupied by the recuperator;
(iii) in at least one of the at least first and second turbo-compressor spools, an inflow axis to the centrifugal compressor is in a direction of the spool axis of rotation of the centrifugal compressor while an outflow axis from the centrifugal compressor is at least substantially orthogonal to the spool axis of rotation;
(iv) in at least one of the at least first and second turbo-compressor spools, an outflow axis from the radial turbine is in a direction of the spool axis of rotation of the radial turbine while an inflow axis to the radial turbine is at least substantially orthogonal to the spool axis of rotation; and
(v) in at least one of the at least first and second turbo-compressor spools, opposing flanges connect the centrifugal compressor and corresponding radial turbine, whereby the centrifugal compressor is independently rotatable about the spool axis of rotation relative to the corresponding radial turbine.

2. The engine of claim 1, wherein (i) is true.

3. The engine of claim 1, wherein (ii) is true.

4. The engine of claim 1, wherein (iii) is true.

5. The engine of claim 1, wherein (iv) is true.

6. The engine of claim 1, wherein (v) is true.

7. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis; and
a second compressed gas from the second compressor exits the second compressor along a sixth flow axis, wherein the first flow axis is transverse to the fifth flow axis.

8. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis; and
a second compressed gas from the second compressor exits the second compressor along a sixth flow axis, wherein the second flow axis is transverse to the sixth flow axis.

9. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis; and
a second compressed gas from the second compressor exits the second compressor along a sixth flow axis, wherein the first flow axis is substantially perpendicular to the fifth flow axis.

10. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis; and
a second compressed gas from the second compressor exits the second compressor along a sixth flow axis, wherein the second flow axis is substantially perpendicular to the sixth flow axis.

11. The engine of claim 1, wherein at least one of the radial inlet turbines comprises ceramic turbine blades.

12. The engine of claim 1, wherein at least one of the radial inlet turbines comprises actively cooled turbine blades.

13. The engine of claim 1, further comprising:
a free power turbine having an inflow axis at least substantially orthogonal to a power output shaft axis of rotation and an outflow axis at least substantially parallel to the power output shaft axis of rotation.

14. The engine of claim 1, wherein at least one of (iii), (iv) and (v) is true and wherein:
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis; and
a second expanded gas from the second turbine exits the second turbine along a fourth flow axis, wherein the fourth flow axis is transverse to the eighth flow axis.

15. The engine of claim 1, wherein at least one of (iii), (iv) and (v) is true and wherein:
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis; and
a second expanded gas from the second turbine exits the second turbine along a fourth flow axis, wherein the third flow axis is transverse to the seventh flow axis.

16. The engine of claim 1, wherein at least one of (iii), (iv) and (v) is true and wherein:
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis; and
a second expanded gas from the second turbine exits the second turbine along a fourth flow axis, wherein the fourth flow axis is substantially perpendicular to the eighth flow axis.

17. The engine of claim 1, wherein at least one of (iii), (iv) and (v) is true and wherein:
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis; and
a second expanded gas from the second turbine exits the second turbine along a fourth flow axis, wherein the third flow axis is substantially perpendicular to the seventh flow axis.

18. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis;
a second compressed gas from the second compressor exits the second compressor along a sixth flow axis;
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis; and
a second expanded gas from the second turbine exits the second turbine along an fourth flow axis, wherein the first flow axis is transverse to the fifth flow axis.

19. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis;
a second compressed gas from the second compressor exits the second compressor along a sixth flow axis;
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis; and
a second expanded gas from the second turbine exits the second turbine along an fourth flow axis, wherein the first flow axis is substantially orthogonal to the fifth flow axis.

20. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a third flow axis;
a second compressed gas from the second compressor exits the second compressor along a fourth flow axis;
a second inlet gas to a first turbine in the second turbo-compressor spool enters the first turbine along a fifth flow axis;
a first expanded gas from the first turbine exits the first turbine along a sixth flow axis;
the first expanded gas to a second turbine in the first turbo-compressor spool enters the second turbine along a seventh flow axis; and
a second expanded gas from the second turbine exits the second turbine along an eighth flow axis, wherein the second and third flow axes are in a plane that is transverse to the plane of the sixth and seventh flow axes.

21. The engine of claim 1, wherein at least one of (iii), (iv) and (v) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a third flow axis;
a second compressed gas from the second compressor exits the second compressor along a fourth flow axis;
a second inlet gas to a first turbine in the second turbo-compressor spool enters the first turbine along a fifth flow axis;
a first expanded gas from the first turbine exits the first turbine along a sixth flow axis;
the first expanded gas to a second turbine in the first turbo-compressor spool enters the second turbine along a seventh flow axis; and
a second expanded gas from the second turbine exits the second turbine along an eighth flow axis, wherein the second and third flow axes are in a plane that is substantially orthogonal to the plane of the sixth and seventh flow axes.

22. A gas turbine engine, comprising:
at least first and second turbo-compressor spools, each of the at least first and second turbo-compressor spools comprising a centrifugal compressor in mechanical communication with a radial inlet turbine wherein a spool axis of rotation for the centrifugal compressor and radial inlet turbine comprise a common shaft;
an intercooler positioned in a fluid path between the first and second turbo-compressor spools;
a recuperator operable to transfer thermal energy from an output gas of a power turbine to a compressed gas produced by the centrifugal compressor of the at least first and second turbo-compressor spools thereby providing a further heated gas; and
a free power spool comprising a radial inlet turbine and a mechanical power output shaft wherein a spool axis of rotation for the radial inlet turbine and the mechanical power output shaft comprise a common shaft; and
a combustor operable to combust a fuel in the presence of the further heated gas, wherein at least one of the following is true:
the combustor is substantially contained within a volume occupied by the recuperator;
(ii) the engine has full power operation at an overall engine compression ratio of about 10:1 to about 20:1;
(iii) in at least one of the at least first and second turbo-compressor spools, an inflow axis to the centrifugal compressor is in a direction of the spool axis of rotation of the centrifugal compressor while an outflow axis from the centrifugal compressor is at least substantially orthogonal to the spool axis of rotation;
(iv) in at least one of the at least first and second turbo-compressor spools turbo-compressor spools, an outflow axis from the radial turbine is in a direction of the spool axis of rotation of the radial turbine while an inflow axis to the radial turbine is at least substantially orthogonal to the spool axis of rotation;
(v) in at least one of the at least first and second turbo-compressor spools turbo-compressor spools, opposing flanges connect the centrifugal compressor and corresponding radial turbine, whereby the centrifugal compressor is independently rotatable about the spool axis of rotation relative to the corresponding radial turbine; and
(vi) the free power turbine having an inflow axis at least substantially orthogonal to a power output shaft axis of rotation and an outflow axis at least substantially parallel to the power output shaft axis of rotation.

23. The gas turbine engine of claim 22, wherein (i) is true.

24. The gas turbine engine of claim 22, wherein (ii) is true.

25. The gas turbine engine of claim 22, wherein (iii) is true.

26. The gas turbine engine of claim 22, wherein (iv) is true.

27. The gas turbine engine of claim 22, wherein (v) is true.

28. The gas turbine engine of claim 22, wherein (vi) is true.

29. The engine of claim 22, wherein at least one of (iii), (iv), (v), and (vi) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis;
a second compressed gas from the second compressor exits the second compressor along a sixth flow axis;
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis;
a second expanded gas exits the second turbine along an fourth flow axis;
a second expanded gas from the second turbine enters the free power turbine along a thirteenth flow axis; and
a third expanded gas from the free power turbine exits the free power turbine along a fourteenth flow axis, wherein the first flow axis is transverse to the fifth flow axis and the fourteenth flow axis is transverse to at least one of the first and fifth flow axes.

30. The engine of claim 22, wherein at least one of (iii), (iv), (v), and (vi) is true and wherein:
a first inlet gas to a first compressor in the first turbo-compressor spool enters the first compressor along a first flow axis;
a first compressed gas from the first compressor exits the first compressor along a second flow axis;
the first compressed gas to a second compressor in the second turbo-compressor spool enters the second compressor along a fifth flow axis;
a second compressed gas from the second compressor exits the second compressor along a sixth flow axis;
a first inlet gas to a first turbine in the second turbo-compressor spool enters the first turbine along a seventh flow axis;
a first expanded gas from the first turbine exits the first turbine along an eighth flow axis;
the first expanded gas to a second turbine in the first turbo-compressor spool enters the second turbine along a third flow axis;
a second expanded gas exits the second turbine along an fourth flow axis;
a second expanded gas from the second turbine enters the free power turbine along a thirteenth flow axis; and
a third expanded gas from the free power turbine ex exits the free power turbine along a fourteenth flow axis, wherein the first flow axis is substantially perpendicular to the fifth flow axis and the fourteenth flow axis is substantially perpendicular to at least one of the first and fifth flow axes.

31. The engine of claim 22, wherein at least one of the radial inlet turbines comprises ceramic turbine blades.

32. The engine of claim 22, wherein at least one of the radial inlet turbines comprises actively cooled turbine blades.
